(19) United States
(12) Patent Application Publication
(10) Pub. No.: US 2006/0095847 A1
(43) Pub. Date: May 4, 2006

(54) Broadcasting service method and apparatus

(75) Inventor: Jong Yeul Suh, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/262,833

(22) Filed: Nov. 1, 2005

(30) Foreign Application Priority Data
Nov. 2, 2004 (KR) 10-2004-0088241

(51) Int. Cl. H04N 7/16; G06F 17/00; G06F 3/00; H04N 7/025; H04N 7/10

(52) U.S. Cl. 715/704; 725/135; 725/32

(57) ABSTRACT

Disclosed herein is a broadcasting service method and system for effectively performing a viewing restriction function. The broadcasting service method includes the steps of: a) generating a plurality of scenes according to each viewing rate classified by a predetermined rule with respect to specific scenes of a single program; and b) constructing a scene chain in time order where the scene chain connects only broadcasting streams of scenes corresponding to the viewing rate transmitted from a broadcasting receiver of a user, among the plurality of scenes, and transmitting the scene chain to the broadcasting receiver of the user. Thus, in the broadcasting receiver or a Personal Video Recorder (PVR) with a storage medium, a restriction function for each rate in relation to viewing and recording can be flexibly and effectively embodied.

This application claims the benefit of Korean Patent Application No. 10-2004-0088241, filed on Nov. 2, 2004, which is hereby incorporated by reference as if fully set forth herein.

### BACKGROUND OF THE INVENTION

1. The field

This document relates to a digital broadcasting receiver, and more particularly to a broadcasting service method and system for viewing restriction.

2. Discussion of the Related Art

With the increasing development and popularization of digital broadcasting technology, the spread of digital television is increasing exponentially. In addition, a conventional digital TV has been developed so as to satisfy various functional requirements of a user, more particularly, a technical side thereof has been increasingly developed so as to provide various functions as well as a simple function of a digital broadcasting reception.

Generally, a large number of broadcasting programs may contain violent or sexual content inappropriate for viewing by specific viewers. Thus, accurate and systematic protection techniques are required for a youth age group with respect to programs containing excessive violence, swearing, or sexual content.

In order to protect specific viewers from the inappropriate contents, viewing ratings (hereinafter a rating referred to as a rate) for each age group are generally used.

Thus, when a broadcasting station provides or transmits movie or broadcasting programs, the broadcasting station provides age rate information to viewers, wherein the age rate information is transmitted as EPG (Electronic Program Guide) data according to standards defined for the data broadcasting. In addition, most of conventional methods for performing the TV viewing restriction function have applied the age rate information.

For example, one conventional TV viewing restriction function is embodied by combining the age rate of the broadcasting program with a viewing restriction algorithm pre-established by a broadcasting receiver. This function of TV viewing restriction is applied to an entire broadcasting program. That is, if the broadcasting program is different from a reference rate pre-established by the receiver, a viewer cannot view the entire broadcasting program.

However, only certain scenes of the broadcasting program have a general effect on the viewing rate of the broadcasting program. Thus, since the viewer cannot view the entire broadcasting program due to certain scenes, the convention function of TV viewing restriction is ineffective.

### SUMMARY OF THE INVENTION

Accordingly, the present invention is directed to a broadcasting service method and system that substantially obviates one or more problems due to limitations and disadvantages of the related art.

An object of the present invention is to provide a broadcasting service method and system, wherein a user can view corresponding differentiated broadcasting streams according to a viewing restriction rate which is pre-established through a broadcasting receiver.

Another object of the present invention is to provide a broadcasting service method and system, wherein, a transmission part which provides a broadcasting program can generate to transmit a plurality of scenes at a specific period or an entire period for every viewing rate with respect to a single program, and a broadcasting receiver can display the scenes of the broadcasting program corresponding to a viewing rate pre-established by a user.

A further object of the present invention is to provide a broadcasting service method and system capable of establishing rate information and performing an accurate receiving function and record function of the broadcasting program in broadcasting service environments.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a broadcasting service method includes the steps of: a) generating a plurality of scenes according to each viewing rate classified by a predetermined rule with respect to specific scenes of a single program; and b) constructing a scene chain in time order where the scene chain connects only broadcasting streams of scenes corresponding to the viewing rate transmitted from a broadcasting receiver of a user, among the plurality of scenes, and transmitting the scene chain to the broadcasting receiver of the user.

In another aspect of the present invention, a broadcasting service method includes the steps of: a) generating a plurality of scenes according to each viewing rate classified by a predetermined rule with respect to specific scenes of a single program, and then transmitting both scene information and rate information therewith; and b) parsing, in time order by means of a broadcasting receiver, only broadcasting streams of scenes corresponding to the viewing rate pre-established by a user among the transmitted plurality of scenes, with reference to the transmitted scene information and rate information, decoding the parsed broadcasting streams, and then displaying the decoded broadcasting streams on a display apparatus.

In another aspect of the present invention, a broadcasting service apparatus includes: a broadcasting station for generating a plurality of scenes according to each viewing rate classified by a predetermined rule with respect to specific scenes of a single program, constructing a scene chain in time order where the scene chain connects only broadcasting streams of scenes corresponding to a viewing rate pre-established by a user, and transmitting the scene chain; and a broadcasting receiver for transmitting the viewing rate pre-established by a user to the broadcasting station, receiving the broadcasting streams constituting the scene chain, decoding the broadcasting streams, and then displaying the decoded broadcasting streams on a display apparatus.

In another aspect of the present invention, a broadcasting service apparatus includes: a broadcasting station for generating a plurality of scenes according to each viewing rate classified by a predetermined rule with respect to specific scenes of a single program, and transmitting both scene information and rate information therewith; and a broadcasting receiver for storing the viewing rate pre-established by a user, parsing in time order only broadcasting streams of scenes corresponding to the viewing rate pre-established by a user among the transmitted plurality of scenes, with reference to the transmitted scene information and rate information, decoding the parsed broadcasting streams, and then displaying the decoded broadcasting streams on a display apparatus.

In another aspect of the present invention, a broadcasting service apparatus includes: a broadcasting station for generating a plurality of scenes according to each viewing rate classified by a predetermined rule with respect to specific scenes of a single program, and transmitting both scene information and rate information therewith; and a broadcasting receiver with a storage medium, wherein the broadcasting receiver stores the transmitted plurality of scenes as well as the scene information and rate information in the storage medium, reads, in time order from the storage medium, only broadcasting streams of scenes corresponding to the viewing rate pre-established by a user using the scene information and rate information when reproducing the scene, decodes the parsed broadcasting streams, and then displays the decoded broadcasting streams on a display apparatus.

In another aspect of the present invention, a broadcasting service apparatus includes: a broadcasting station for generating a plurality of scenes according to each viewing rate classified by a predetermined rule with respect to specific scenes of a single program, and transmitting both scene information and rate information therewith; and a broadcasting receiver with a storage medium, wherein, the broadcasting receiver parses in time order only broadcasting streams of scenes corresponding to the viewing rate pre-established by a user among the transmitted plurality of scenes using the transmitted scene information and rate information, stores the parsed broadcasting streams, reads the broadcasting streams stored in the storage medium when reproducing the scene, decodes the stored broadcasting streams, and then displays the decoded broadcasting streams on a display apparatus.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a certain this application, illustrate embodiment(s) of the invention and together with the description serve to explain the principle of the invention. In the drawings:

FIG. 1 is a view illustrating a data structure of a broadcasting program for a broadcasting service according to an embodiment of the present invention;

FIG. 2 is a view illustrating the configuration of a scene chain for embodying a viewing restriction function in a broadcasting service method according to an embodiment of the present invention;

FIG. 3 is a view illustrating a data structure of scene and rate information in a broadcasting service method according to an embodiment of the present invention;

FIG. 4 is a view illustrating a concept of a broadcasting receiver for performing a function of a scene viewing restriction function in bidirectional broadcasting environments according to a first preferred embodiment of the present invention;

FIG. 5 is a view illustrating a concept of a broadcasting receiver for performing a function of a scene viewing restriction function in multi-broadcasting environments according to a second preferred embodiment of the present invention; and

FIG. 6 is a view illustrating a concept of a broadcasting receiver having a storage medium for performing a reproduction restriction function by establishing a reproduction rate in a broadcasting service method according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Prior to describing the present invention, it should be noted that most terms disclosed in the present invention correspond to general terms well known in the art, but some terms have been selected by the applicant as necessary and will hereinafter be disclosed in the following description of the present invention. Therefore, it is preferable that the terms defined by the applicant be understood on the basis of their meanings in the present invention.

As noted the above, only a certain scenes among the entire broadcasting program have a general effect on the rate of the broadcasting program.

Thus, if a broadcasting station can replace scenes which have an effect on the rate of the broadcasting program into different scenes, or transmit other scenes except for corresponding scenes among the broadcasting program, a viewer can view corresponding broadcasting program with satisfying the pre-established viewing rate.

The present invention is to provide differentiated content to a user according to viewing standards such as an age of the user and the like.

That is, according to the present invention, the broadcasting station (which includes a broadcasting program producer and a broadcasting program provider) generates a plurality of scenes of a specific period or an entire period for each viewing rate with respect to a single program which is broadcasted in real-time or nonreal-time, and transmits the generated scenes. In this case, a program which is re-constructed to a scene corresponding to the viewing rate established by the broadcasting receiver of a user is transmitted, or a program corresponding to the overall generated scenes is transmitted. In the former case, the corresponding broadcasting receiver displays the received broadcasting program as it is. In the latter case, the corresponding broadcasting receiver re-constructs a broadcasting program to a scene corresponding to the established viewing rate, and displays the re-constructed broadcasting program. Thus, the viewer rarely encounters the circumstance that they are incapable of viewing a broadcasting program due to certain scenes or fractions of scenes thereof.

The former which is referred to as a first preferred embodiment of the present invention and the latter which is referred to as a second preferred embodiment of the present invention will hereinafter be described with reference to the annexed drawings.

### First Preferred Embodiment

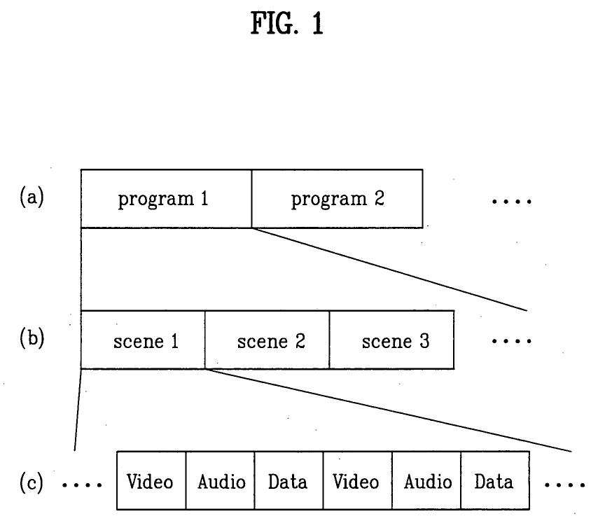

FIG. 1 is a view illustrating a data structure of a broadcasting program for a broadcasting service of viewing restriction according to an embodiment of the present invention.

Referring to FIG. 1, each broadcasting program as shown in (a) of FIG. 1 is composed of a plurality of scenes as shown in (b) of FIG. 1. The scene represents a standard unit for embodying a viewing restriction function, wherein an additional syntax is not present in a data stream so as to display a scene or divide a scene. That is, the scenes are used as a unit for transmitting rate information which is required to embody the viewing restriction function. In addition, the scenes is formed that scene information is added to data in connection with video and audio data.

In addition, a basic data structure with respect to one scene in (b) of FIG. 1 has a structure as shown in (c) of FIG. 1. That is, the structure is formed that a video stream, an audio stream and a data stream are multiplexed into one stream.

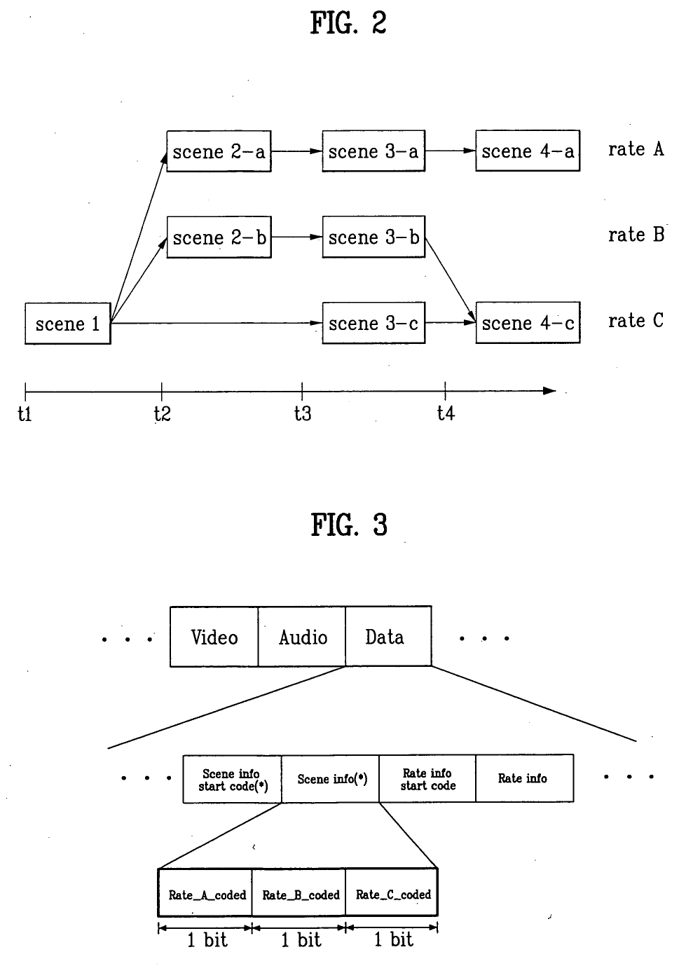

FIG. 2 is a view illustrating the configuration of a scene chain for embodying a viewing restriction function in a broadcasting service method according to an embodiment of the present invention. Herein, the scene chain plays an informant role in realization of the viewing restriction function.

In this case, a broadcasting station produces a plurality of scenes according to each viewing rate with respect to scenes having the same content. At this time, a form that the scenes having the same rate are connected in time order is defined to as a scene chain according to the present invention.

Referring to FIG. 2, a total of three viewing rates are present, wherein, it is assumed that a rate A corresponds to the highest viewing rate level, and a rate C corresponds to the lowest viewing rate level at which all age groups can view the corresponding scenes.

In addition, the broadcasting station according to the present invention may include not only an original broadcasting station but also include a transmission part such as an external broadcasting program producer, etc. Herein, it is assumed that bi-directional communication between the broadcasting station and broadcasting receiver is possible. In this case, a viewing rate which is established in a specific broadcasting receiver is transmitted to the corresponding broadcasting station or all broadcasting stations, and the corresponding broadcasting station manages the rate information for each broadcasting receiver.

The broadcasting station may transmit the corresponding scene chain according to the viewing rate which is established by a user with the broadcasting receiver. This is referred to as a first preferred embodiment of the present invention.

For example, when the user establishes the viewing rate to a rate B, the transmission part transmits the scene chain composed of scene 1→scene 2-b→scene 3-b→scene 4-c.

In constructing this scene chain, the scene having the highest viewing restriction level among overall viewable scenes according to the currently-established rate at a specific time point is selected. For example, when the viewing rate is established to rate B, scene 3-b and scene 3-c can be selected at time point t3. Among these scenes, scene 3-b having the highest viewing restriction level is included in the scene chain according to the present invention.

When a selected scene with respect to a specific period according to the currently-established rate is not present, the broadcasting station does not transmit video and/or audio signal of the corresponding period, and the corresponding broadcasting receiver does not output the video and/or audio signal of the corresponding period. Instead, the corresponding broadcasting receiver may output additional On Screen Display (OSD) signals, etc. When recording the broadcasting program, the corresponding period is prevented from being recorded. For example, when the viewing rate is established to a rate A, since the selected scene is not present at time point t2, the broadcasting station does not transmit the video and/or audio signal of the corresponding period.

FIG. 3 is a view illustrating a data structure of scene and rate information in a broadcasting service method according to an embodiment of the present invention. Herein, the scene and rate information is included in a conventional data stream.

Referring FIG. 3, a scene information start code (Scene info start code) indicating that the scene information is placed prior to the scene information (Scene info) included in the data stream, and a rate information start code (Rate info start code) indicating the rate information is placed prior to the rate information (Rate info).

As a rule, the rate information is transmitted once with respect to each scene, and is included in the data stream firstly generated at each scene. A size of the scene information is proportional to the number of rates specified through a current broadcasting service. Since it is assumed that a total of three rates are present according to the preferred embodiment of the present invention, the scene information may be composed of 3 bits. At this time, each bit represents whether a bit-stream corresponding to the rate of the corresponding scene location is included in the current scene.

For example, assuming that the viewing rate established by a user is a rate A, and the broadcasting station transmits the scene chain corresponding to the viewing rate A established by the user with the broadcasting receiver according to the first preferred embodiment of the present invention, a scene information value transmitted for each scene is ‘100’. That is, when the scene information value is ‘100’, it represents that a stream corresponding to the viewing rate A is encoded in the current scene, and the encoded stream is transmitted.

On the other hand, assuming that the broadcasting station transmits all scenes having all viewing rates, and that a reception part re-constructs the scene chain corresponding to the viewing rate A -established by the user according to a second preferred embodiment of the present invention which is described later, the scene information value transmitted for each scene may be any one of 8 values (100, 001, 010, 011, 100, 101, 110 and 111). For example, when the scene information value is ‘101’, a stream corresponding to a rate A and a rate C is encoded in the current scene, and then the encoded stream is transmitted. As a result, the reception part can parse only a stream which is appropriate to the viewing rate established by the user through the current broadcasting program. This parsing of the stream can be performed through a filtering operation using the rate information.

The rate information is identification information indicating a rate of video and audio streams which are currently transmitting. As a rule, the rate information corresponding to each video Element Stream (ES) is transmitted.

That is, using the scene information, a decoder can determine whether a stream having a specific rate with respect to the currently-transmitted scene is present. In addition, using the rate information, the decoder can determine whether a decoding of the currently-transmitted video stream is performed.

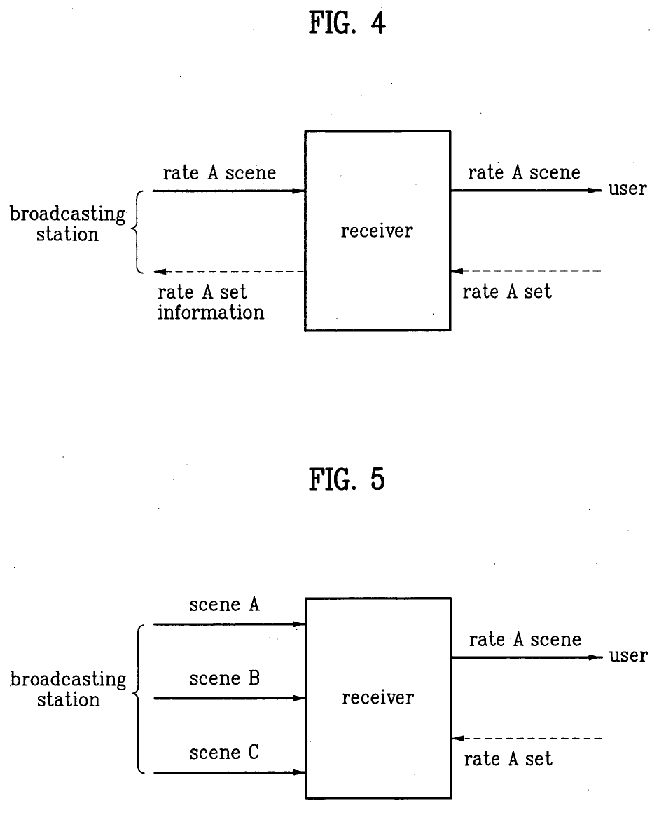

FIG. 4 is a view illustrating a concept of a broadcasting receiver for performing a scene viewing restriction function in bidirectional broadcasting environments according to a first preferred embodiment of the present invention.

Referring to FIG. 4, it is assumed that the broadcasting station and the broadcasting receiver are connected via wired/wireless means such as a terrestrial, and a satellite, a cable and a dedicated line, etc., and are capable of performing bi-directional communication. Herein, the user establishes the viewing rate to the broadcasting receiver using an input means such as a remote controller, or the like. Thus, the broadcasting receiver transmits the viewing rate established by the user as well as its own identification code. The broadcasting station manages the viewing rate information for each broadcasting receiver, and transmits the corresponding scene chain to the corresponding broadcasting receiver.

Herein, the broadcasting receiver of the user must include an appropriate function for establishing the rate, and must include a function for transmitting corresponding information to the transmission part. In addition, the broadcasting receiver allows the user to variably establish the rate establishment rules. That is, the broadcasting receiver must include a user-defined function for variably establishing the witching rate according to the time or a specific channel.

For example, assuming that the user establishes the viewing rate to a rate A, a corresponding broadcasting receiver transmits the viewing rate information having the rate A to the broadcasting station. Referring to a program of FIG. 2, the corresponding broadcasting station transmits the scene chain to the corresponding broadcasting receiver, wherein, the scene chain is composed of scene 1→scene 2-a→scene 3-a→scene 4-a among the plurality of scenes.

Thus, the corresponding broadcasting receiver decodes the scene chain of scene 1→scene 2-a→scene 3-a→scene 4-a, and displays the decoded scene on a TV display, and thereby the user can view the program corresponding to the scene of the rate A.

### Second Preferred Embodiment

FIG. 5 is a view illustrating a concept of a broadcasting receiver for performing a function of a scene viewing restriction function in multi-broadcasting environments according to a second preferred embodiment of the present invention.

As shown in this drawing, according to the second preferred embodiment of the present invention, a multi-program transmittable broadcasting is capable of simultaneously transmitting all scenes, given sufficient transmission capacity, or the transmission medium has sufficient bandwidth such as an SD-class (Standard Definition-class) broadcasting environments. In addition, the second preferred embodiment of the present invention can be employed when unidirectional communication between the broadcasting station and the broadcasting receiver is possible.

In a case where bi-directional communication between the broadcasting station and the broadcasting receiver is possible, the rate information established by the user may be transmitted to the broadcasting station. This is an option of a system designer.

In addition, when the broadcasting station receives the rate information through the broadcasting receiver, the broadcasting station may construct the scene chain corresponding to the received rate information and transmit the constructed scene chain to the corresponding broadcasting receiver, or may transmit all scenes. Similarly, this is an option of a system designer.

The broadcasting receiver may filter a stream corresponding to the rate information pre-established by the user among the transmitted streams, and store or display the filtered stream. The filtering is performed using the rate information (rate info) in the data stream. That is, the broadcasting receiver parses only video ES corresponding to the viewing rate established by the user using the rate information supplemented for each video ES, and decodes the parsed video ES.

For example, it is assumed that the user establishes the viewing rate to a rate A, and the scene information value is established to ‘111’, that is, a stream corresponding to rates A, B and C is encoded in the current scene at the time point t3 as shown in FIG. 2, such that the encoded stream is transmitted.

Then, the corresponding broadcasting receiver filters only video ES having the rate A using the rate information supplemented for each video ES at the time point t3, decodes the filtered video ES, and displays the decoded video ES. As a result, the user can view a program corresponding to the scenes having the rate A.

At this time, when the broadcasting receiver constructs the scene chain, in the same manner as the above first preferred embodiment of the present invention, the scene having the highest viewing restriction level among overall viewable scenes according to the currently-established rate at a specific time point is selected. In addition, when a selected scene with respect to a specific period according to the currently-established rate is not present, the broadcasting receiver does not output the video and/or audio signal of the corresponding period. Instead, the broadcasting receiver may output additional On Screen Display (OSD) signals, etc.

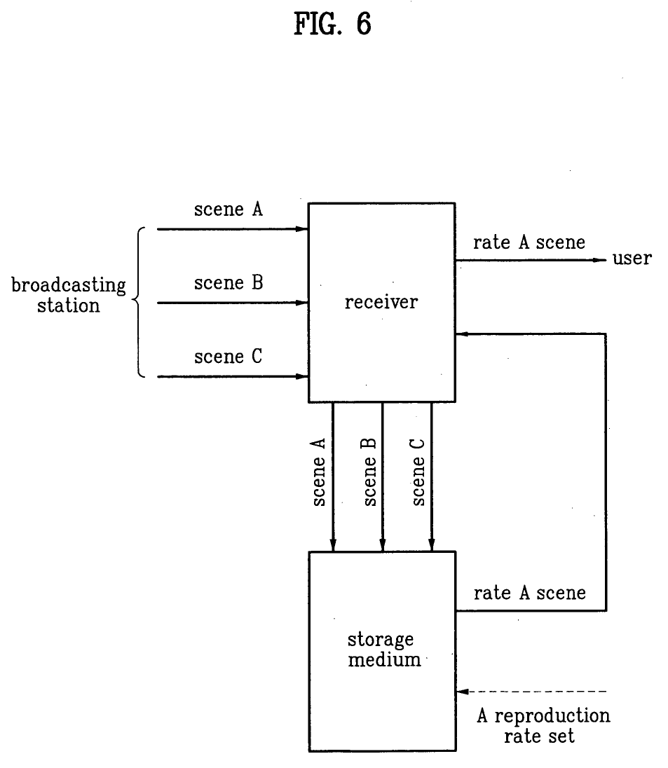

FIG. 6 is a view illustrating a concept of a broadcasting receiver having a storage medium for performing a reproduction restriction function by establishing a reproducing rate in a broadcasting service method according to an embodiment of the present invention. Herein, the broadcasting receiver having a storage medium may be a Personal Video Recorder (PVR) having a Hard Disc Drive (HDD).

Referring to FIG. 6, assuming that the PVR apparatus can employ multi stream broadcasting, the PVR apparatus can employ a reproduction restriction function by storing the overall scene chains or the overall rate streams for the same scene, and then establishing a reproduction rate.

At this time, it is assumed that the user establishes the reproduction viewing rate during reproducing the scene, In addition, it is assumed that the user pre-establishes the reproduction viewing rate. In addition, it is assumed that the broadcasting station transmits the overall scene chains or the overall rate streams (For example, scene A, scene B and scene C) for the same scene.

Then, the PVR apparatus stores the received broadcasting stream having the overall rates in the storage medium such as the HDD. Next, when the user selects the reproduction of the broadcasting program, the PVR apparatus reads the broadcasting stream of the scene chain corresponding to the reproduction rate established by the user among the broadcasting streams which are stored with a selected reproduction file name, decodes the read broadcasting stream, and displays the decoded broadcasting stream.

That is, the PVR apparatus must generate the scene chain for each rate with respect to the stored program. This may be achieved through either a hardware or software based system.

For example, it is assumed that the user establishes the viewing rate to a rate A, and the scene information value is established to ‘111’, that is, a stream corresponding to rates A, B and C is encoded in the current scene at the time point t3 as shown in FIG. 2, such that the encoded stream is transmitted.

Then, the PVR apparatus stores the broadcasting stream having overall rates in the storage medium. Next, when the user selects reproduction of the broadcasting stream, the PVR apparatus reads only video ES having the rate A using the rate information supplemented for each video ES, decodes the read video ES, and displays the decoded video ES. As a result, the user can view a program corresponding to the scenes having the rate A.

Herein, the scene chain generated through the broadcasting station represents a connection structure of transmitting streams according to the viewing rate, wherein the user or the broadcasting receiver need not additionally manage the scene chain information. However, the PVR apparatus itself as shown in FIG. 6 needs to generate and manage the scene chain.

In the above case where the PVR apparatus itself generates the scene chain and stores corresponding transport stream, the PVR apparatus can generate a pointer list of the scene chain for each rate using a packet number of the stored transport stream as a pointer. Thus, when the user reproduces the stored program after establishing the rate, the PVR apparatus can control a reproduction process using the pointer list of the scene chain for corresponding rate.

On the other hand, the PVR apparatus may filter only stream of the scene corresponding to the reproduction viewing rate established by the user among all streams with respect to the same scene transmitted through the broadcasting station, and store the filtered stream in the storage medium. At this time, the PVR apparatus need not construct the scene chain when reproducing the scene.

Thus, the user establishes the viewing or reproduction rate via the above-described processes, and thereby it is possible to accurately and effectively perform the viewing restriction function according to automatic methods.

As apparent from the above description, the present invention provides a broadcasting service method and system, wherein, since a broadcasting station or a program provider produces additional scenes corresponding to a certain scenes which have an effect on a viewing rate with respect to broadcasting programs, and selectively transmits only scenes corresponding to a viewing rate established by a user, a broadcasting receiver or a Personal Video Recorder (PVR) can accurately and effectively employ a restriction function for each rate in relation to viewing and recording.

In addition, the present invention provides a broadcasting service method and system, wherein, when multiple program transmission is possible, that is, when sufficient bandwidth is available, or when uni-directional transmission is possible, a broadcasting station produces additional scenes corresponding to a certain scenes which have an effect on a viewing rate with respect to broadcasting programs, and transmits the overall scenes, and a broadcasting receiver selectively receives and stores appropriate scenes according to pre-established rate information, thereby a restriction function for each rate in relation to viewing and recording can be flexibly and effectively embodied.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A broadcasting service method comprising the steps of:
a) generating a plurality of scenes according to each viewing rate classified by a predetermined rule with respect to specific scenes of a single program; and
b) constructing a scene chain in time order where the scene chain connects only broadcasting streams of scenes corresponding to the viewing rate transmitted from a broadcasting receiver of a user, among the plurality of scenes, and transmitting the scene chain to the broadcasting receiver of the user.

2. The broadcasting service method as set forth in claim 1, wherein the scene generated according to each viewing rate includes at least one video element stream (ES), and information of the scene is transmitted after being included in a data stream.

3. The broadcasting service method as set forth in claim 2, wherein the information of the scene is transmitted after being included in a first data stream generated for each scene.

4. The broadcasting service method as set forth in claim 2, wherein each video ES is transmitted after including rate information for representing a viewing rate of each video ES.

5. The broadcasting service method as set forth in claim 1, wherein, the step of b) selects the highest restricted scene among the overall scenes viewable according to the viewing rate currently set at a specific time point, and then constructs the scene chain.

6. The broadcasting service method as set forth in claim 1, wherein, in the step of b), a corresponding video and/or audio signal is not transmitted when the scene selected according to the viewing rate currently set at a specific time point is not present.

7. A broadcasting service method comprising the steps of:
a) generating a plurality of scenes according to each viewing rate classified by a predetermined rule with respect to specific scenes of a single program, and then transmitting both scene information and rate information therewith; and
b) parsing, in time order by means of a broadcasting receiver, only broadcasting streams of scenes corresponding to the viewing rate pre-established by a user among the transmitted plurality of scenes, with reference to the transmitted scene information and rate information, decoding the parsed broadcasting streams, and then displaying the decoded broadcasting streams on a display apparatus.

8. The broadcasting service method as set forth in claim 7, wherein, the step of b) selects the highest restricted scene among the overall scenes viewable according to the viewing rate currently established at a specific time point, and then constructs the scene chain.

9. The broadcasting service method as set forth in claim 7, wherein, the step of b) does not output corresponding video and/or audio signal to the display apparatus when the scene selected according to the viewing rate currently established at a specific time point is not present.

10. A broadcasting service apparatus comprising:
a broadcasting station for generating a plurality of scenes according to each viewing rate classified by a predetermined rule with respect to specific scenes of a single program, constructing a scene chain in time order where the scene chain connects only broadcasting streams of scenes corresponding to a viewing rate pre-established by a user, and transmitting the scene chain; and
a broadcasting receiver for transmitting the viewing rate pre-established by a user to the broadcasting station, receiving the broadcasting streams constituting the scene chain, decoding the broadcasting streams, and then displaying the decoded broadcasting streams on a display apparatus.

11. The broadcasting service apparatus as set forth in claim 10, wherein the scene generated according to each viewing rate in the broadcasting station includes at least one video element stream (ES), and information of the scene is transmitted after being included in a data stream.

12. The broadcasting service apparatus as set forth in claim 11, wherein the information of the scene is transmitted after being included in a first data stream generated from each scene.

13. The broadcasting service apparatus as set forth in claim 11, wherein each video ES is transmitted after including rate information for representing a viewing rate of each video ES.

14. The broadcasting service apparatus as set forth in claim 10, wherein, the broadcasting station selects the highest restricted scene among the overall scenes viewable according to the viewing rate currently established at a specific time point, and then constructs the scene chain.

15. The broadcasting service apparatus as set forth in claim 10, wherein, the broadcasting station does not transmit a corresponding video and/or audio signal when the scene selected according to the viewing rate currently established at a specific time point is not present.

16. A broadcasting service apparatus comprising:
a broadcasting station for generating a plurality of scenes according to each viewing rate classified by a predetermined rule with respect to specific scenes of a single program, and transmitting both scene information and rate information therewith; and
a broadcasting receiver for storing the viewing rate pre-established by a user, parsing in time order only broadcasting streams of scenes corresponding to the viewing rate pre-established by a user among the transmitted plurality of scenes, with reference to the transmitted scene information and rate information, decoding the parsed broadcasting streams, and then displaying the decoded broadcasting streams on a display apparatus.

17. The broadcasting service apparatus as set forth in claim 16, wherein, the broadcasting station selects the highest restricted scene among the overall scenes viewable according to the viewing rate currently established at a specific time point, and then constructs the scene chain.

18. The broadcasting service apparatus as set forth in claim 16, wherein, the broadcasting station does not output corresponding video and/or audio signal to the display apparatus when the scene selected according to the viewing rate currently established at a specific time point is not present.

19. A broadcasting service apparatus comprising:
a broadcasting station for generating a plurality of scenes according to each viewing rate classified by a predetermined rule with respect to specific scenes of a single program, and transmitting both scene information and rate information therewith; and
a broadcasting receiver with a storage medium, wherein the broadcasting receiver stores the transmitted plurality of scenes as well as the scene information and rate information in the storage medium, reads, in time order from the storage medium, only broadcasting streams of scenes corresponding to the viewing rate pre-established by a user using the scene information and rate information when reproducing the scene, decodes the parsed broadcasting streams, and then displays the decoded broadcasting streams on a display apparatus.

20. A broadcasting service apparatus comprising:
a broadcasting station for generating a plurality of scenes according to each viewing rate classified by a predetermined rule with respect to specific scenes of a single program, and transmitting both scene information and rate information therewith; and
a broadcasting receiver with a storage medium, wherein, the broadcasting receiver parses in time order only broadcasting streams of scenes corresponding to the viewing rate pre-established by a user among the transmitted plurality of scenes using the transmitted scene information and rate information, stores the parsed broadcasting streams, reads the broadcasting streams stored in the storage medium when reproducing the scene, decodes the stored broadcasting streams, and then displays the decoded broadcasting streams on a display apparatus.
